(19) United States
(12) Patent Application Publication
(10) Pub. No.: US 2026/0296274 A1
(43) Pub. Date: Oct. 1, 2026

(54) VEHICLE SEAT

(71) Applicant: HONDA MOTOR CO., LTD., Tokyo (JP)

(72) Inventor: Taiji MISONO, Tokyo (JP)

(21) Appl. No.: 19/564,147

(22) Filed: Mar. 11, 2026

(30) Foreign Application Priority Data
Mar. 26, 2025 (JP) 2025-052257

(51) Int. Cl. B60N 2/42; B60N 2/888

(52) U.S. Cl. CPC B60N 2/42; B60N 2/888

(57) ABSTRACT

A vehicle seat includes a seatback. The seatback includes a frame and an impact absorbing member. When the vehicle seat is viewed in an erected state in which the seatback is erected, the impact absorbing member includes a left side portion, a right side portion, and an upper side portion. The left side portion is fixed to a left frame that is a left portion of the frame when viewed from front, and extends up to a position above the frame. The right side portion is fixed to a right frame that is a right portion of the frame when viewed from front, and extends up to a position above the frame. The upper side portion is disposed above the frame and integrally connects an upper end portion of the left side portion and an upper end portion of the right side portion.

This application is based on and claims the benefit of priority from Japanese Patent Application No. 2025-052257, filed on 26 Mar. 2025, the content of which is incorporated herein by reference.

### BACKGROUND OF THE INVENTION

### Field of the Invention

The present invention relates to a vehicle seat that is mounted in a vehicle.

### Related Art

A vehicle seat typically includes a seat part and a seatback. The seatback includes a frame and a cushion member.

Patent Document 1: Japanese Unexamined Patent Application, Publication No. 2023-093003

### SUMMARY OF THE INVENTION

In the case of a collision or a similar event of a vehicle, there is a possibility that an occupant in a rear seat collides with, for example, an upper portion of a seatback of a predetermined seat. For this reason, the seatback is preferably capable of absorbing an impact applied from the rear. On the other hand, if the rigidity of the frame of the seatback is lowered to facilitate absorption of the impact, the rigidity of the entire seatback will become insufficient, and the seated person may feel discomfort.

The present invention has been made in view of the above circumstances, and an object the present invention is to a technique that makes it easy to absorb an impact from a rear without lowering the rigidity of a frame of a seatback.

The present inventors have found that the above object can be achieved by providing, to an upper portion of a seatback, an impact absorbing member that is separate from a frame, and have achieved the present invention. The present invention provides a vehicle seat described below in (1) to (6).

(1) A first aspect of the present invention relates to a vehicle seat including a seatback, the seatback including a frame and an impact absorbing member. when the vehicle seat is viewed in an erected state in which the seatback is erected, the impact absorbing member includes a left side portion fixed to a left frame that is a left portion of the frame when viewed from front, the left side portion extending up to a position above the frame, a right side portion fixed to a right frame that is a right portion of the frame when viewed from front, the right side portion extending up to a position above the frame, and an upper side portion disposed above the frame and integrally connecting an upper end portion of the left side portion and an upper end portion of the right side portion.

Due to the above-described configuration, in the case of a collision or a similar event of a vehicle, when an occupant in a rear seat collides with the rear surface of the upper portion of the seatback, the impact can be absorbed by the impact absorbing member. In addition, since the impact absorbing member is separate from the frame, it is unnecessary to reduce the rigidity of the frame in order to facilitate absorption of impact. Thus, the above-described configuration facilitates absorption of impact applied from the rear, without lowering the rigidity of the frame.

(2) According to a second aspect, in the vehicle seat described in (1) above, in the seatback, a back panel member having a plate shape and extending along a rear surface of the seatback is disposed rearward of an upper portion of the frame, and an upper portion of the back panel member is supported by the upper side portion.

Due to the above-described configuration, in the case of a collision or a similar event of a vehicle, when an occupant in a rear seat collides with the back panel member provided in an upper portion of the seatback, the impact can be absorbed by the impact absorbing member.

(3) According to a third aspect, in the vehicle seat described in (1) or (2) above, when the vehicle seat is viewed in the erected state, the left side portion of the impact absorbing member is fixed to a front surface of the left frame, and the right side portion of the impact absorbing member is fixed to a front surface of the right frame.

Due to the above-described configuration, when an occupant collides with the upper portion of the seatback from the rear, the impact absorbing member is less likely to be pressed onto the left frame and/or the right frame, as compared with a case where the left side portion is fixed to a rear surface of the left frame and the right side portion is fixed to a rear surface of the right frame. Therefore, the impact can be absorbed further efficiently.

(4) According to a fourth aspect, in the vehicle seat described in any one of (1) to (3) above, a cross-sectional area of a cross section of the impact absorbing member taken along a plane orthogonal to an extending direction of the impact absorbing member is smaller than a cross-sectional area of a cross section of each of the left frame and the right frame taken along a plane orthogonal to a respective extending direction of the left frame and the right frame.

Due to the above-described configuration, the impact absorbing member is more easily crushed than the frame. As a result, it is possible to ensure the impact absorbing performance of the impact absorbing member while ensuring the rigidity of the frame. In addition, the small cross-sectional area of the impact absorbing member results in space saving, thereby contributing to a reduction in the size of the upper portion of the seatback.

(5) According to a fifth aspect, in the vehicle seat described in any one of (1) to (4) above, when the vehicle seat is viewed in the erected state, a headrest is attached to an upper portion of the seatback, and the impact absorbing member extends to pass through a portion just behind the headrest.

Due to the above-described configuration, in the case of a collision or a similar event of a vehicle, when an occupant in a rear seat collides with the portion just behind the headrest, the impact can be absorbed by the impact absorbing member. Therefore, the head of the occupant in the rear seat can be protected, and the head of an occupant seated in the vehicle seat can be protected.

(6) According to a sixth aspect, in the vehicle seat described in any one of (1) to (5) above, when the vehicle seat is viewed in the erected state, a headrest is attached to an upper portion of the seatback, the seatback includes a cushion member that extends up to a position above an upper end of the impact absorbing member, and the seatback includes a linear member that extends to pass through a portion in the cushion member, the portion being located above the upper end of the impact absorbing member.

Due to the above-described configuration, the rigidity of the portion above the upper end of the impact absorbing member in the cushion member is improved by the linear member. Therefore, the shape of an upper portion of the seatback can be easily maintained.

As described above, the configuration described in (1) above makes it easy to absorb an impact from a rear without lowering the rigidity of a frame of a seatback. Further, the configurations described (2) to (6) citing (1) can exert respective additional effects.

### BRIEF DESCRIPTION OF THE DRAWINGS

FIG. 1 is a perspective view illustrating a vehicle seat according to a first embodiment;

FIG. 2 is a perspective view illustrating an interior of the vehicle seat;

FIG. 3 illustrates a portion of FIG. 2 on an enlarged scale;

FIG. 4 is a perspective view illustrating a state in which an airbag has been deployed from the state of FIG. 2;

FIG. 5 illustrates the vehicle seat as viewed from front;

FIG. 6 illustrates a portion of FIG. 5 on an enlarged scale;

FIG. 7 illustrates the vehicle seat as viewed from right;

FIG. 8 is a perspective view illustrating an upper portion of the vehicle seat;

FIG. 9 illustrates the upper portion of the vehicle seat as viewed from right;

FIG. 10 is a perspective view illustrating the upper portion of the vehicle seat having a headrest removed therefrom;

FIG. 11 is a perspective view illustrating an interior of the upper portion of the vehicle seat of FIG. 10; and

FIG. 12 is a perspective view illustrating the state of the FIG. 11 with omission of some further components.

### DETAILED DESCRIPTION OF THE INVENTION

Embodiments of the present invention will be described below with reference to the drawings. It should be noted that the present invention is not limited to the following embodiments in any sense, and can be appropriately modified and implemented within a range not departing from the spirit of the present invention.

### First Embodiment

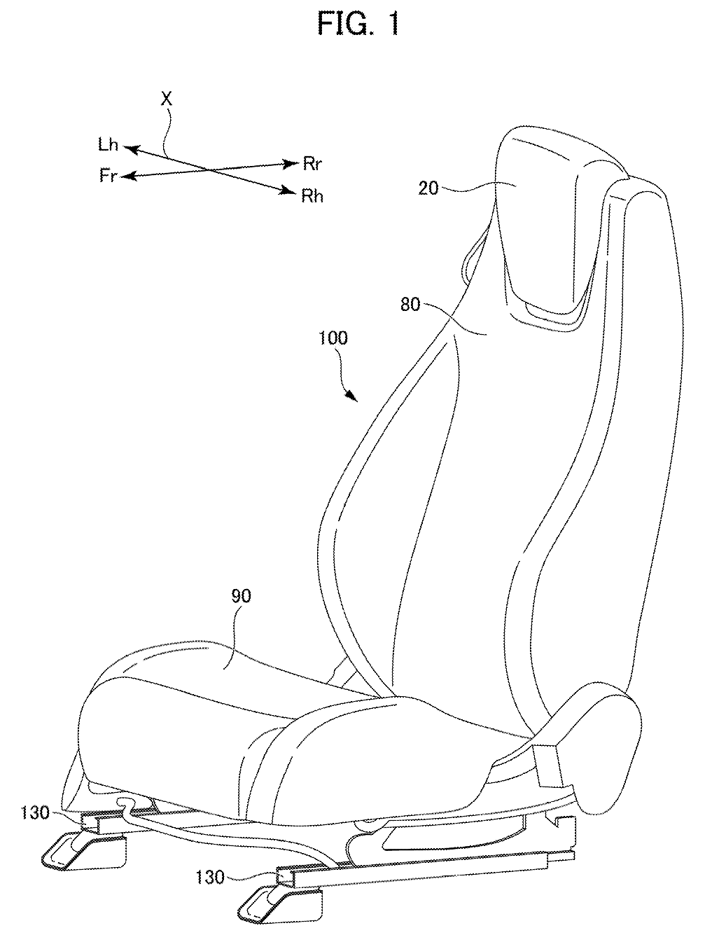

As illustrated in FIG. 1, a vehicle seat 100 includes a seat part 90, a seatback 80, and a headrest 20. The seat part 90, the seatback 80, and the headrest 20 are components separate from each other. The seatback 80 is configured to be reclinable.

Hereinafter, a state in which the seatback 80 is erected to the maximum extent as illustrated in FIG. 1 is referred to as an "erected state". Unless otherwise specified, the following description pertains to the vehicle seat when viewed in the erected state.

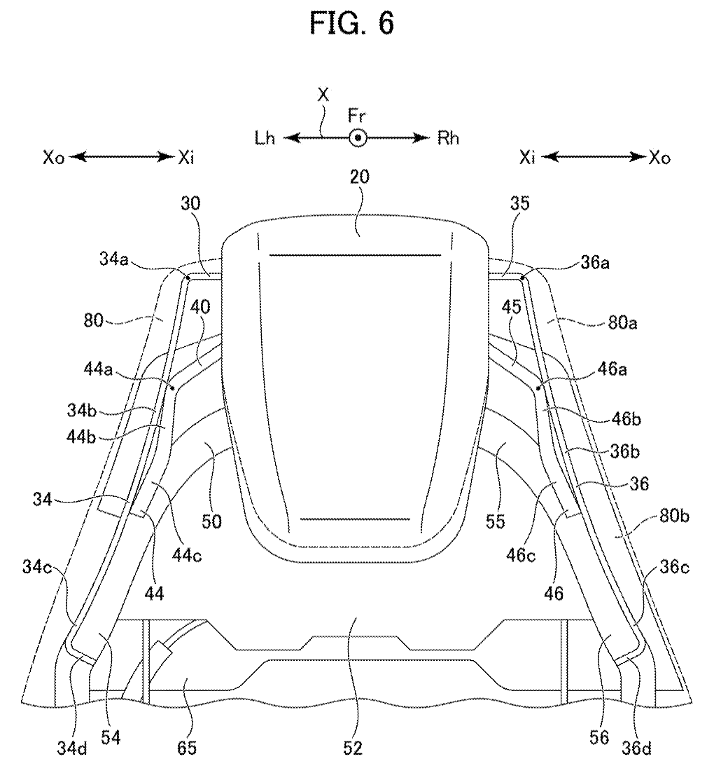

Hereinafter, as illustrated in FIG. 6, the width direction of the vehicle seat 100 is referred to as a "lateral direction X". In the lateral direction X, a side close to the center of gravity of the vehicle seat 100 is referred to as a "lateral inner side Xi", and a side opposite to the lateral inner side Xi is referred to as a "lateral outer side Xo". A positional relationship in which a component coincides in position with another component when viewed in the lateral direction X is phrased as the component is disposed/located "just beside" the other component. A positional relationship in which a component is located toward the front Fr with respect to, and coincides in position with, another component when viewed in the front-rear direction is phrased as the component is disposed/located "just in front of" the other component. A positional relationship in which a component is located toward the rear Rr with respect to, and coincides in position with, another component when viewed in the front-rear direction is phrased as the component is disposed/located "just behind" the other component. In the following description, the left viewed from the front Fr is referred to as "left", and the right viewed from the front Fr is referred to as "right". Therefore, the left Lh mentioned below indicates one side in the lateral direction X, and the right Rh mentioned below indicates the other side in the lateral direction X.

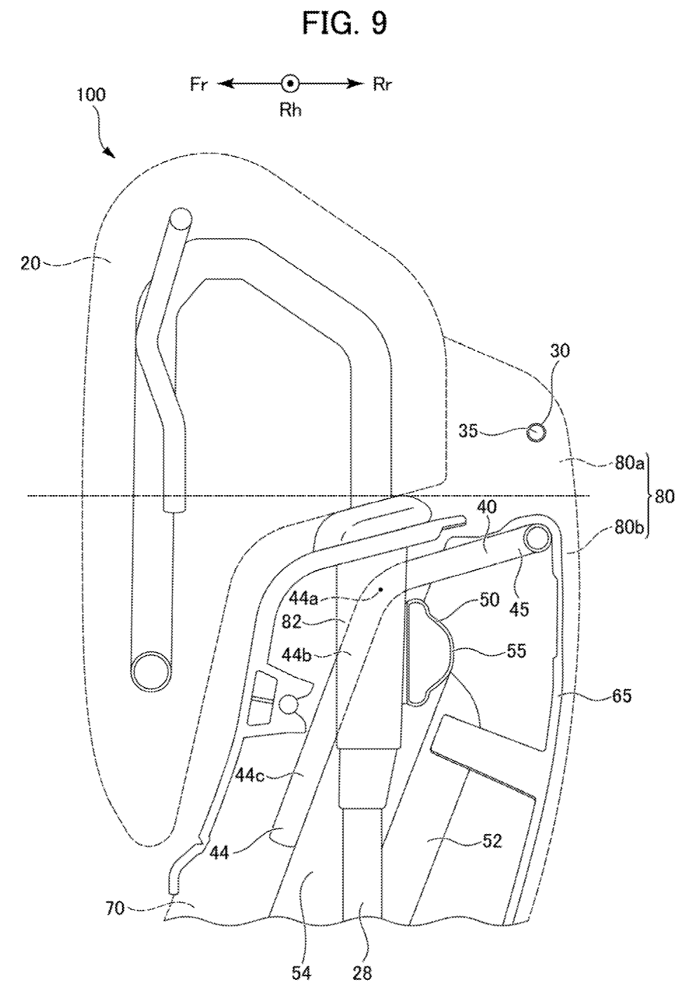

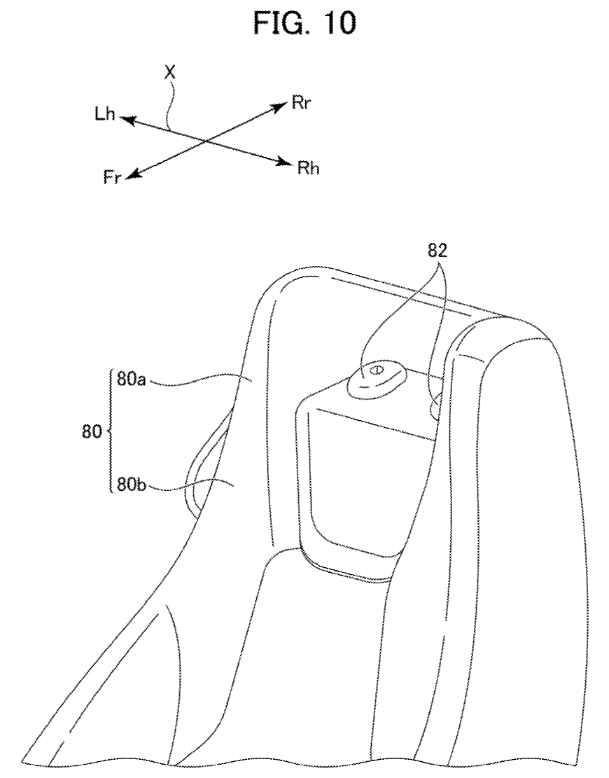

As illustrated in FIG. 10, the seatback 80 includes insertion portions 82 into which stays 28 of the headrest 20 are inserted. Hereinafter, as illustrated in FIG. 9, a region of the seatback 80 above the upper end of the insertion portion 82 is referred to as a "seatback upper region 80a", and a region of the seatback 80 below the upper end of the insertion portion 82 is referred to as a "seatback main region 80b".

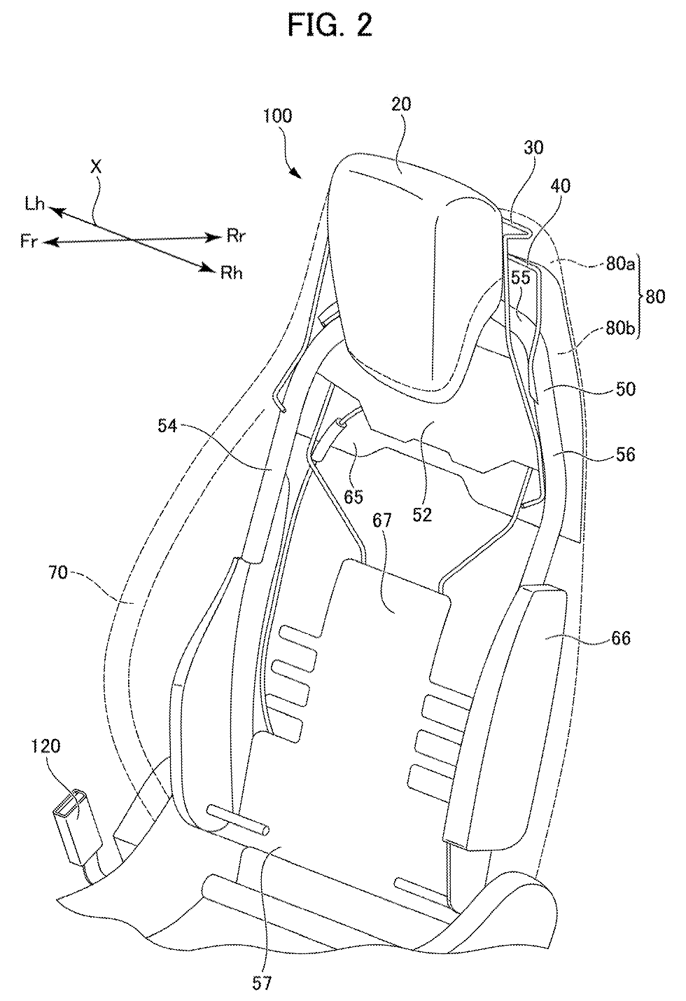

As illustrated in FIG. 2, the seatback 80 includes a frame 50 and a cushion member 70. The frame 50 is composed of metal and is installed within the seatback main region 80b. On the other hand, the cushion member 70 is composed of urethane or the like, and is disposed in a range across the seatback upper region 80a and the seatback main region 80b. Therefore, the cushion member 70 extends up to a position above the upper end of the frame 50.

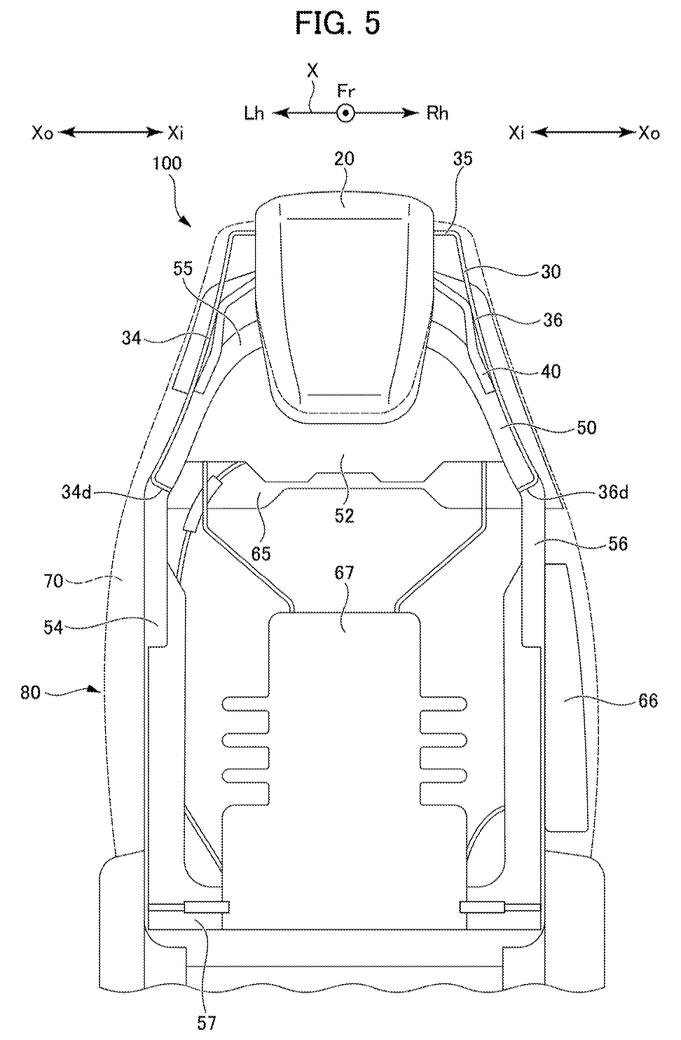

As illustrated in FIG. 5, the frame 50 includes a left frame 54, an upper frame 55, a right frame 56, and a lower frame 57. The left frame 54 is provided in a left portion in the seatback 80. The right frame 56 is provided in a right portion in the seatback 80. The upper frame 55 integrally connects an upper end portion of the left frame 54 and an upper end portion of the right frame 56. The lower frame 57 integrally connects a lower end portion of the left frame 54 and a lower end portion of the right frame 56.

As illustrated in FIG. 6, the upper portion of the left frame 54 and the upper portion of the right frame 56 extend downward toward the lateral outer side Xo, respectively. Specifically, the upper portion of the left frame 54 extends downward toward the left Lh, and the upper portion of the right frame 56 extends downward toward the right Rh.

As illustrated in FIG. 9, the stays 28 of the headrest 20 are inserted into the insertion portions 82 of the seatback 80. Accordingly, the headrest 20 is attached to be disposed just in front of a range including the seatback upper region 80a.

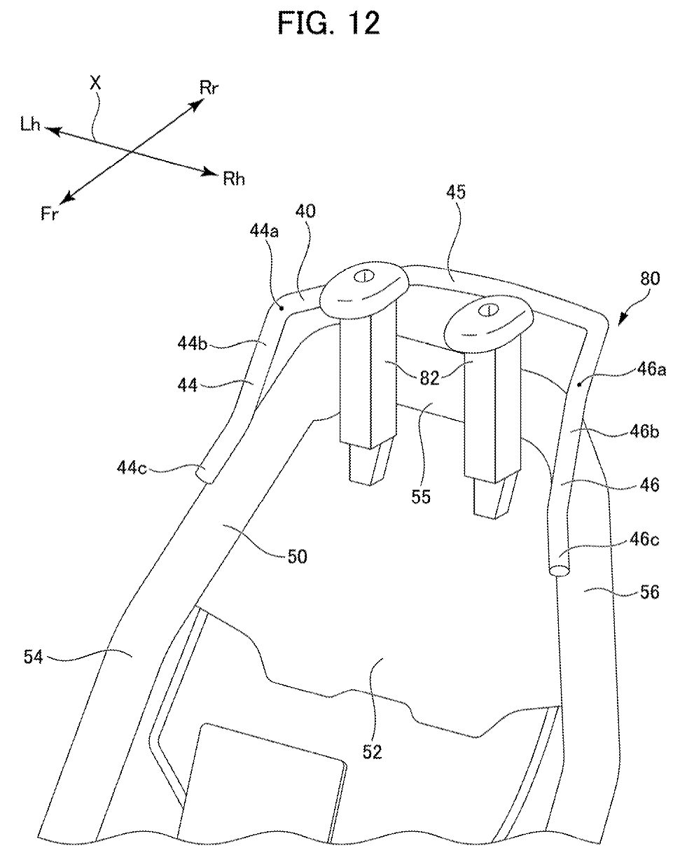

As illustrated in FIG. 9, an impact absorbing member 40 composed of metal is provided in an upper portion of the seatback main region 80b. As illustrated in FIG. 12, the impact absorbing member 40 includes a left side portion 44, an upper side portion 45, and a right side portion 46. The left side portion 44 includes a lower portion 44c fixed to the front surface of the left frame 54. The right side portion 46 includes a lower portion 46c fixed to the front surface of the right frame 56.

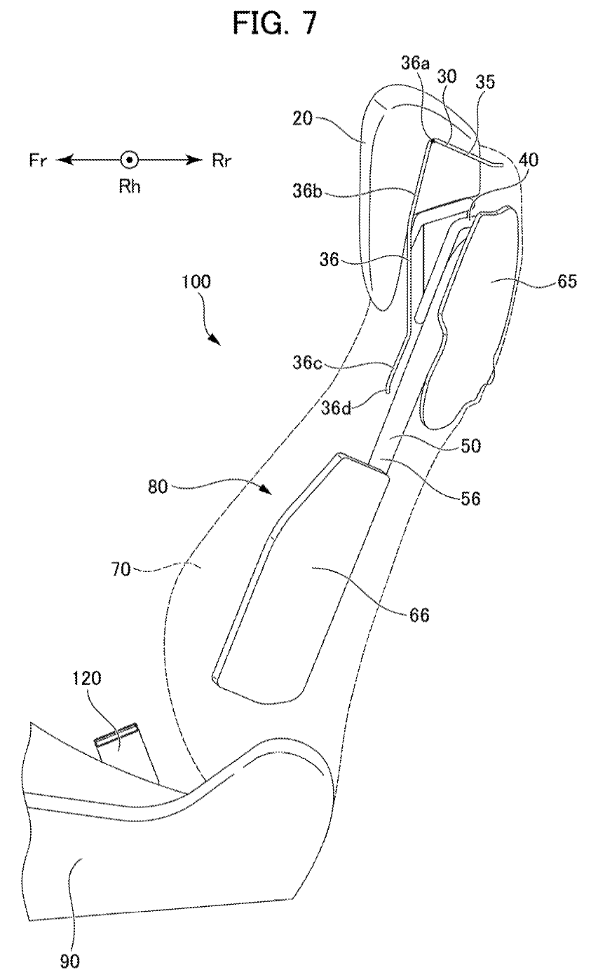

The left side portion 44 and the right side portion 46 both extend up to a position above the upper end of the frame 50. The upper side portion 45 is disposed above the upper end of the frame 50 and integrally connects an upper end portion of the left side portion 44 and an upper end portion of the right side portion 46. Therefore, as illustrated in FIG. 7, the impact absorbing member 40 extends to pass through a portion just behind the headrest 20.

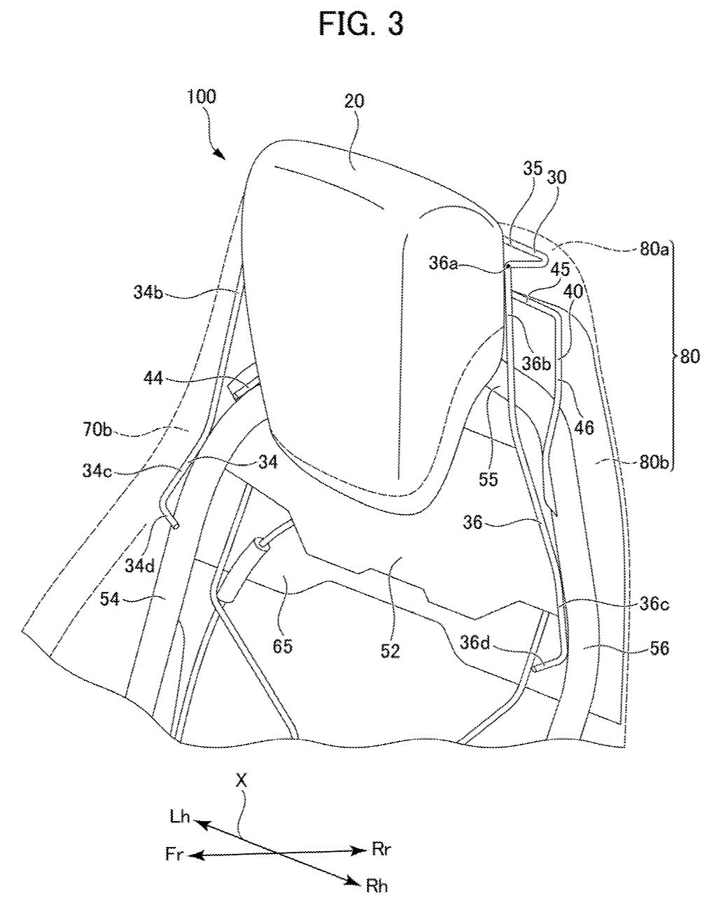

As illustrated in FIG. 3, in the seatback 80, an upper back panel member 65 having a plate shape and extending along the rear surface of the seatback 80 is disposed rearward of an upper portion of the frame 50. Note that the "upper back panel member 65" may be referred to as the "back panel member". As illustrated in FIG. 9, an upper portion of the upper back panel member 65 is supported by the upper side portion 45 of the impact absorbing member 40. On the other hand, a lower portion of the upper back panel member 65 is supported by the frame 50, as illustrated in FIG. 7.

Referring to FIG. 12, a cross-sectional area of a cross section of the impact absorbing member 40 taken along a plane orthogonal to the extending direction of the impact absorbing member 40 is smaller than a cross-sectional area of a cross section of each of the left frame 54 and the right frame 56 taken along a plane orthogonal to the respective extending direction of the frames 54 and 56. Therefore, the impact absorbing member 40 has a lower rigidity than the frame 50.

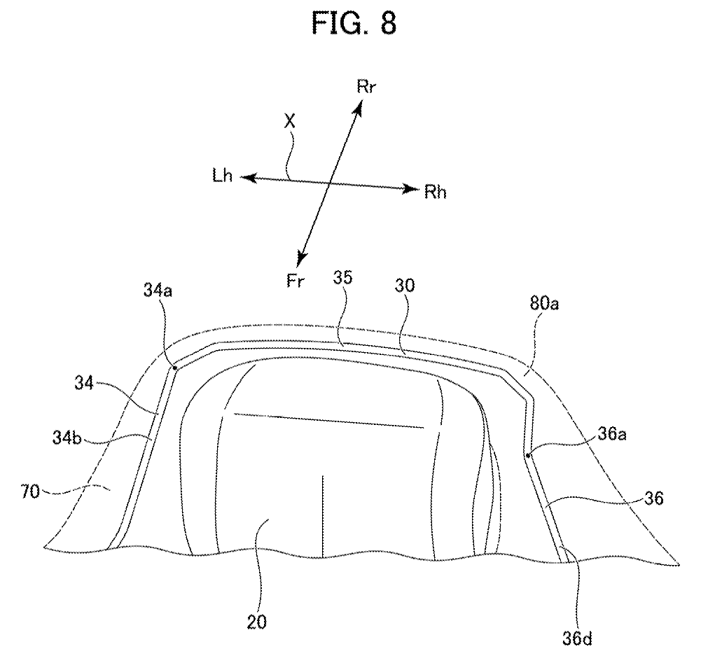

As illustrated in FIG. 7, a linear member 30 protruding upward relative to the impact absorbing member 40 is provided inside the upper portion of the seatback 80. As illustrated in FIG. 8, the linear member 30 is composed of metal and is insert-molded in an upper portion of the cushion member 70.

As illustrated in FIG. 6, the linear member 30 includes a left leg portion 34, a laterally-extending side portion 35, and a right leg portion 36. Hereinafter, the left leg portion 34 and the right leg portion 36 will be collectively referred to as "leg portions 34, 36". As illustrated in FIG. 8, an upper end 34a of the left leg portion 34 is located just beside a side of the headrest 20 closer to the left Lh in the seatback upper region 80a. The laterally-extending side portion 35 extends from the upper end 34a of the left leg portion 34 to an upper end 36a of the right leg portion 36 through a portion just behind the headrest 20 in the seatback upper region 80a. The upper end 36a of the right leg portion 36 is located just beside a side of the headrest 20 closer to the right Rh in the seatback upper region 80a. As illustrated in FIG. 6, the left and right leg portions 34, 36 extend from the opposite ends of the laterally-extending side portion 35 to the seatback main region 80b.

The left leg portion 34 includes a left inclined portion 34c that extends along an upper portion of the left frame 54. The right leg portion 36 includes a right inclined portion 36c that extends along an upper portion of the right frame 56. Hereinafter, the left inclined portion 34c and the right inclined portion 36c are collectively referred to as "inclined portions 34c, 36c".

Lower end portions 34d, 36d of the leg portions 34, 36 of the linear member 30 extend such that the leading ends thereof are located closer to the lateral inner side Xi than the base ends thereof. As illustrated in FIG. 5, a side airbag 66 is attached to a portion of the seatback 80 located below the lower end portion 36d of the leg portion 36.

Referring to FIG. 6, a cross-sectional area of a cross section of the linear member 30 taken along a plane orthogonal to the extending direction of the linear member 30 is smaller than a cross-sectional area of a cross section of the impact absorbing member 40 taken along a plane orthogonal to the extending direction of the impact absorbing member 40. Therefore, the linear member 30 has a lower rigidity than the impact absorbing member 40.

Hereinafter, the present embodiment will be described in more detail.

As illustrated in FIG. 1, the vehicle seat 100 is slidable in the front-rear direction (Fr-Rr direction) along rails 130. As illustrated in FIG. 2, a seat belt 120 is provided to the vehicle seat 100. A reinforcing member 52 that connects an upper portion of the left frame 54, the upper frame 55, and an upper portion of the right frame 56 is provided behind an upper portion of the frame 50. The above-described upper back panel member 65 is provided in an upper portion of the seatback 80 behind the reinforcing member 52. A lower back panel member 67 is provided inside a lower portion of the frame 50. As illustrated in FIG. 12, the two insertion portions 82, each of which is a cylindrical member protruding upward from the reinforcing member 52, are arranged side by side in the lateral direction X.

An upper end 44a of the left side portion 44 of the impact absorbing member 40 illustrated in FIG. 12 is located closer to the left Lh than the insertion portions 82. The upper side portion 45 extends from the upper end 44a of the left side portion 44 to the upper end 46a of the right side portion 46 through a portion just behind the insertion portions 82. An upper end 46a of the right side portion 46 is located closer to the right Rh than the insertion portions 82.

As illustrated in FIG. 6, the left side portion 44 and the right side portion 46 extend downward toward the lateral outer side Xo, respectively. Specifically, the left side portion 44 extends downward toward the left Lh. On the other hand, the right side portion 46 extends downward toward the right Rh. In the front view of FIG. 6, the angle formed by the extending direction of the lower portion 44c of the left side portion 44 with respect to the up-down direction is larger than the angle formed by the extending direction of the upper portion 44b of the left side portion 44 with respect to the up-down direction. Similarly, in the front view, the angle formed by the extending direction of the lower portion 46c of the right side portion 46 with respect to the up-down direction is larger than the angle formed by the extending direction of the upper portion 46b of the right side portion 46 with respect to the up-down direction. The lower portion 44c of the left side portion 44 extends along an upper portion of the left frame 54. The lower portion 46c of the right side portion 46 extends along an upper portion of the right frame 56.

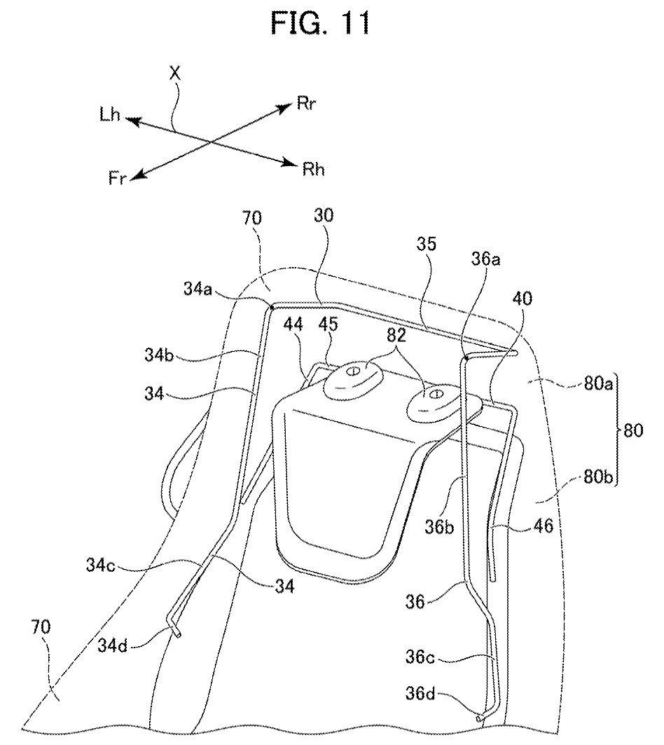

As illustrated in FIG. 11, the laterally-extending side portion 35 of the linear member 30 is disposed above the upper side portion 45 of the impact absorbing member 40. The lower ends of the linear member 30 are located below the lower ends of the impact absorbing member 40.

As illustrated in FIG. 6, the leg portions 34, 36 of the linear member 30 include connecting portions 34b, 36b between the upper ends 34a, 36a and the inclined portions 34c, 36c, respectively. Like the inclined portions 34c, 36c, the connecting portions 34b, 36b also extend downward toward the lateral outer side Xo, respectively. However, the connecting portions 34b, 36b are different from the inclined portions 34c, 36c in that the connecting portions 34b, 36b are spaced upward from the frame 50 and do not extend along the upper portion of the left frame 54 or the upper portion of the right frame 56. Further, in the front view of FIG. 6, the angle formed by the extending direction of each of the inclined portions 34c, 36c with respect to the up-down direction is larger than the angle formed by the extending direction of each of the connecting portions 34b, 36b with respect to the up-down direction.

In the following, configurations and effects of the impact absorbing member 40 and peripheral components thereof illustrated in FIG. 12 will be summarized.

The left side portion 44 of the impact absorbing member 40 is fixed to the left frame 54 and extends up to a position above the frame 50. The right side portion 46 of the impact absorbing member 40 is fixed to the right frame 56 and extends up to a position above the frame 50. The upper side portion 45 of the impact absorbing member 40 is disposed above the frame 50 and integrally connects the upper end 46a of the right side portion 46 and the upper end 44a of the left side portion 44.

Therefore, in the case of a collision or a similar event of the vehicle, when an occupant in the rear seat collides with the rear surface of the upper portion of the seatback 80 illustrated in FIG. 9, the impact can be absorbed by the impact absorbing member 40. In addition, because the impact absorbing member 40 is separate from the frame 50, it is unnecessary to reduce the rigidity of the frame 50 in order to facilitate absorption of impact. In this way, the present embodiment facilitates absorption of impact applied from the rear, without lowering the rigidity of the frame 50.

More specifically, the upper back panel member 65 having a plate shape and extending along the rear surface of the seatback 80 is disposed rearward of the upper portion of the frame 50. An upper portion of the upper back panel member 65 is supported by the upper side portion 45. Therefore, in the case of a collision or a similar event of the vehicle, when an occupant in the rear seat collides with upper back panel member 65, the impact can be absorbed by the impact absorbing member 40.

As illustrated in FIG. 12, the left side portion 44 of the impact absorbing member 40 is fixed to the front surface of the left frame 54. The right side portion 46 of the impact absorbing member 40 is fixed to the front surface of the right frame 56. Therefore, when an occupant collides with the upper portion of the seatback 80 from the rear Rr, the impact absorbing member 40 is less likely to be pressed onto the left frame 54 and/or the right frame 56, as compared with a case where the left side portion 44 is fixed to the rear surface of the left frame 54 and the right side portion 46 is fixed to the rear surface of the right frame 56. Therefore, the impact can be absorbed further efficiently.

The cross-sectional area of a cross section of the impact absorbing member 40 taken along a plane orthogonal to the extending direction of the impact absorbing member 40 is smaller than the cross-sectional area of a cross section of each of the left frame 54 and the right frame 56 taken along a plane orthogonal to the respective extending direction of the frames 54 and 56. Therefore, the impact absorbing member 40 is more easily be crushed than the frame 50. As a result, it is possible to ensure the impact absorbing performance of the impact absorbing member 40 while ensuring the rigidity of the frame 50. In addition, the small cross-sectional area of the impact absorbing member 40 results in space saving, thereby contributing to a reduction in the size of the upper portion of the seatback 80.

As illustrated in FIG. 9, the impact absorbing member 40 extends to pass through a portion just behind the headrest 20. Therefore, in the case of a collision or a similar event of the vehicle, when an occupant in the rear seat collides with a portion just behind the headrest 20, the impact can be absorbed by the impact absorbing member 40. Therefore, the head of the occupant in the rear seat can be protected, and the head of the person seated in the vehicle seat 100 can be protected.

In the following, configurations and effects of the linear member 30 and peripheral components thereof illustrated in FIG. 3 will be summarized.

The linear member 30 extends through a portion above the upper end of the impact absorbing member 40 in the cushion member 70. This configuration improves the rigidity of the portion above the upper end of the impact absorbing member 40 in the cushion member 70. Therefore, the shape of the upper portion of the seatback 80 can be easily maintained.

More specifically, as illustrated in FIG. 8, the linear member 30 extends to pass through the seatback upper region 80a. Due to this configuration, the rigidity of the seatback upper region 80a is improved by the linear member 30. Therefore, the shape of the seatback upper region 80a can be easily maintained.

As illustrated in FIG. 6, the laterally-extending side portion 35 of the linear member 30 extends from a location closer to the left Lh than the headrest 20 to a location closer to the right Rh than the headrest 20 through a portion just behind the headrest 20 in the seatback upper region 80a where the frame 50 is absent. The leg portions 34, 36 of the linear member 30 extend from the opposite ends of the laterally-extending side portion 35 to the seatback main region 80b where the frame 50 is disposed. Therefore, the linear member 30 is stably supported, whereby the stability of the seatback upper region 80a is increased. Therefore, for example, in a case where an occupant in the rear seat pulls the seatback upper region 80a toward the rear Rr, the seatback upper region 80a is suppressed from bending toward the rear Rr.

As illustrated in FIG. 8, in the seatback upper region 80a, the linear member 30 extends to pass through a portion just beside the side of the headrest 20 closer to the left Lh, a portion just behind the headrest 20, and a portion just beside the side of the headrest 20 closer to the right Rh. Therefore, the rigidity of the peripheral portion of the headrest 20 in the upper portion of the seatback 80 can be efficiently improved.

As illustrated in FIG. 6, the upper portion of the left frame 54 and the upper portion of the right frame 56 extend downward toward the lateral outer side Xo, respectively. The left leg portion 34 of the linear member 30 includes the left inclined portion 34c that extends along the upper portion of the left frame 54. The right leg portion 36 of the linear member 30 includes the right inclined portion 36c that extends along the upper portion of the right frame 56. Therefore, the left leg portion 34 and the right leg portion 36 of the linear member 30 extend along the left frame 54 and the right frame 56 to become more spaced away from a contact portion with the back of the seated person, in the downward direction. Therefore, the seated person is less likely to feel discomfort or the like.

As illustrated in FIG. 6, the lower end portions 34d, 36d of the leg portions 34, 36 of the linear member 30 extend such that the leading ends thereof are located closer to the lateral inner side Xi than the base ends thereof. Therefore, in the case of a collision or a similar event of the vehicle, even when a load is applied to the linear member 30, the lower end portions 34d, 36d of the leg portions 34, 36 can be prevented from projecting from the vehicle seat 100 toward the front or the lateral outer side Xo.

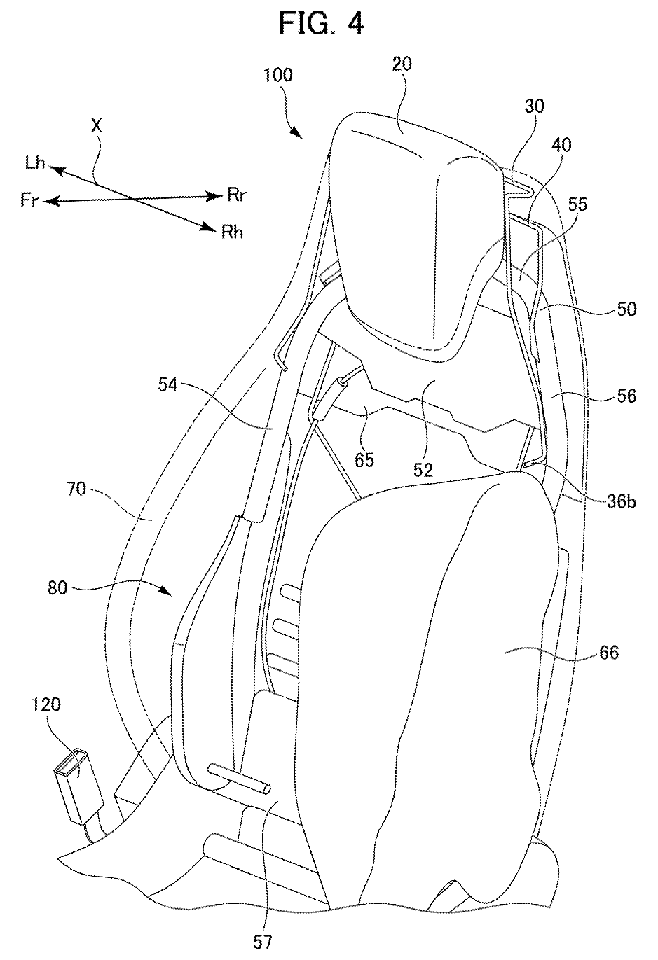

As illustrated in FIG. 5, the side airbag 66 is attached to a portion of the seatback 80 located below the lower end portion 36d of the leg portion 36. Therefore, as compared with a case where the lower end portion 36d of the leg portion 36 of the linear member 30 extends vertically downward, the side airbag 66 is less likely to be damaged when the side airbag 66 is deployed, as illustrated in FIG. 4.

The linear member 30 illustrated in FIG. 8 is insert-molded in the cushion member 70. Therefore, it is possible to prevent or reduce abnormal noise that can be generated due to rubbing of the linear member 30 against the cushion member 70. Further, since the linear member 30 is composed of metal, in the case of a collision or a similar event of the vehicle, when an occupant in the rear seat hits their head against a portion of the seatback 80 above the impact absorbing member 40 illustrated in FIG. 9, the impact can be absorbed by the deformation of the linear member 30. Therefore, the head of the occupant in the rear seat can be protected, and the head of the occupant seated in the vehicle seat 100 can be protected.

### EXPLANATION OF REFERENCE NUMERALS

20: Headrest
28: Stay of headrest
30: Linear member
40: Impact absorbing member
44: Left side portion
45: Upper side portion
46: Right side portion
50: Frame
54: Left frame
56: Right frame
65: Upper back panel member (back panel member)
70: Cushion member
80: Seatback
90: Seat part
100: Vehicle seat
Fr: Front
Lh: Left
Rh: Right
Rr: Rear
X: Lateral direction
Xi: Lateral inner side
Xo: Lateral outer side

What is claimed is:

1. A vehicle seat comprising a seatback,
the seatback including a frame and an impact absorbing member, wherein
when the vehicle seat is viewed in an erected state in which the seatback is erected, the impact absorbing member includes
a left side portion fixed to a left frame that is a left portion of the frame when viewed from front, the left side portion extending up to a position above the frame,
a right side portion fixed to a right frame that is a right portion of the frame when viewed from front, the right side portion extending up to a position above the frame, and
an upper side portion disposed above the frame and integrally connecting an upper end portion of the left side portion and an upper end portion of the right side portion.

2. The vehicle seat according to claim 1, wherein
in the seatback, a back panel member having a plate shape and extending along a rear surface of the seatback is disposed rearward of an upper portion of the frame, and
an upper portion of the back panel member is supported by the upper side portion.

3. The vehicle seat according to claim 1, wherein
when the vehicle seat is viewed in the erected state,
the left side portion of the impact absorbing member is fixed to a front surface of the left frame, and
the right side portion of the impact absorbing member is fixed to a front surface of the right frame.

4. The vehicle seat according to claim 1, wherein a cross-sectional area of a cross section of the impact absorbing member taken along a plane orthogonal to an extending direction of the impact absorbing member is smaller than a cross-sectional area of a cross section of each of the left frame and the right frame taken along a plane orthogonal to a respective extending direction of the left frame and the right frame.

5. The vehicle seat according to claim 1, wherein
when the vehicle seat is viewed in the erected state,
a headrest is attached to an upper portion of the seatback, and
the impact absorbing member extends to pass through a portion just behind the headrest.

6. The vehicle seat according to claim 1, wherein
when the vehicle seat is viewed in the erected state,
a headrest is attached to an upper portion of the seatback,
the seatback includes a cushion member that extends up to a position above an upper end of the impact absorbing member, and
the seatback includes a linear member that extends to pass through a portion in the cushion member, the portion being located above the upper end of the impact absorbing member.
